(19) United States
(12) Patent Application Publication
(10) Pub. No.: US 2002/0075488 A1
(43) Pub. Date: Jun. 20, 2002

(54) Image recording apparatus and method of shading correction utilizing said image recording apparatus

(75) Inventor: Tomohiko Ito, Kaisei-machi (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/004,826

(22) Filed: Dec. 7, 2001

(30) Foreign Application Priority Data
Dec. 8, 2000 (JP) 374411/2000

(51) Int. Cl. G06F 15/00; B41J 1/00

(52) U.S. Cl. 358/1.3; 358/1.1

(57) ABSTRACT

A density pattern based on density pattern data, which represents a density pattern having uniform density, is recorded on a recording sheet by a thermal head. Then, the recording sheet is conveyed by an endless belt, with the conveyance direction matched to a widthwise direction of the recording sheet. By this conveyance, the density pattern is detected by a CCD, which is fixedly positioned in the vicinity of the thermal head, thus obtaining shading correction data. Image data, which represents an image to be recorded on the recording sheet, is corrected by the shading correction data, and corrected image data is obtained thereby. An image based on the corrected image data is recorded on the recording sheet.

### BACKGROUND OF THE INVENTION

1. Field of the Invention

The present invention relates to an image recording apparatus that records a two dimensional image onto a recording medium as well as a method of shading correction utilizing said image recording apparatus.

2. Description of the Related Art

The recording of image data onto a recording medium such as a photosensitive material utilizing an image recording apparatus such as a laser printer, a thermal transfer printer or the like, is conventionally performed. The source of the image data is, for example, photographic film, from which the image has been read photoelectrically, a stimulable phosphor with a radiation image recorded thereon for medical purposes, from which the image has been read out, and the like. With regard to the image recording apparatus used as described above, an image is recorded two dimensionally by a conveyance means such as a conveyance roller or an endless belt conveying the recording medium in a sub scan direction that is substantially perpendicular to the direction of the image's length (a main scan direction) while an image drafting means such as a laser light source or a thermal head drafts a line form image on said recording medium.

In an image recording apparatus as described above, partial reductions in image density (shading) of the image recorded on the recording medium in a main scan direction can arise from uneven irradiation by the laser, irregularities in the thermal elements that make up the thermal head, or the like. This shading in turn causes uneven image density in the image recorded on the recording medium. To compensate, a density pattern for shading correction is recorded on the recording medium, and said density pattern is detected by a detection means of the image recording apparatus, such as a CCD. By the detection of said pattern, shading correction data is obtained, and image recording onto the recording medium is performed while correcting the image data according to said shading correction data.

The shading correction data is obtained as described below. The density pattern for shading correction is recorded by the image drafting means in a band form on the recording medium. Said recording medium is conveyed by the conveyance means until it is in a position where said density pattern can be detected by the detection means. Then, the shading correction data is obtained by moving the detection means in a main scan direction.

With regard to an image recording apparatus as described above, as it was necessary to provide a mechanism to move the detection means in a main scan direction in order to obtain the shading correction data, the structure of the apparatus became complicated, and the cost of the apparatus became high.

### SUMMARY OF THE INVENTION

The present invention has been developed in view of the above described circumstances. It is an object of the present invention to provide an image recording apparatus that is capable of obtaining shading correction data with a simplified construction, as well as a method of shading correction utilizing said apparatus.

The image recording apparatus of the present invention comprises an image drafting means that drafts a line form image on a portion of a recording medium; and a conveyance means that conveys said recording medium in a direction substantially perpendicular to the lengthwise direction of said drafted line form image; wherein said image is recorded two dimensionally on said recording medium by said conveyance means conveying said recording medium in said conveyance direction as said image drafting means drafts said line form image, further comprising a detection means fixedly positioned in relation to said conveyed recording medium.

As the “image drafting means”, any means may be employed that is capable of drafting a line form image on a recording medium. Specifically, in the case that the image recording apparatus is a laser printer, a modulator that modulates the laser light source as well as the laser light according to image data may be employed. Alternately, in the case that the image recording apparatus is a thermal transfer printer, a thermal head having a plurality of thermal elements arranged linearly may be employed.

As the “conveyance means”, paired rollers that convey a recording medium sandwiched therebetween, an endless belt that conveys a recording medium mounted thereon, or the like may be employed.

As the “detection means”, any means may be employed that is capable of photoelectrically reading out a density pattern for shading correction. Specifically, A CCD may be employed. Alternately, a combination of a light emitting element such as an LED, an LD, a laser, or a lamp and a light receiving element such as a PD, a CCD, a CMOS sensor, or a phototransistor may be employed.

As the “recording medium”, a photosensitive material may be employed in the case that the image recording apparatus is a laser printer, and a non-photosensitive sheet may be employed in the case that said apparatus is a thermal transfer printer.

As the “density pattern for shading correction”, a pattern having a uniform density may be employed. This uniform density pattern is a pattern of an image drafted with uniform density in the case that the image drafting means ideally drafts the image in a uniform manner. Note that it is necessary for the “density pattern for shading correction”, to be detectable by the detection means, the linear recording is repeated to record said pattern in a band form having a certain thickness.

It is preferable for the image recording apparatus of the present invention to be formed so that the aforementioned image drafting means as well as the aforementioned conveyance means are provided within a housing. It is also preferable that an opening be provided in said housing in the vicinity of the aforementioned conveyance means, extending in the direction of conveyance thereof.

With regard to the image recording apparatus of the present invention, it is preferable that the image drafting means is a thermal head.

Further, with regard to the image recording apparatus of the present invention, it is preferable that the conveyance means is a means that is capable of varying the conveyance speed of the aforementioned recording medium.

The first method of shading correction according to the present invention is a method of shading correction that utilizes the image recording apparatus of the present invention comprising the steps of: recording a density pattern for shading correction on a recording medium; obtaining said recording medium on which said density pattern for shading correction has been recorded; conveying said recording medium having said density pattern recorded thereon in a direction that substantially matches the lengthwise direction of said density pattern; detecting said density pattern by a detection means; and obtaining shading correction data based on the detection result of said detection means.

The second method of shading correction according to the present invention is a method of shading correction that utilizes a image recording apparatus of the present invention which is capable of varying the conveyance speed comprising the steps of: recording a density pattern for shading correction on a recording medium; obtaining said recording medium on which said density pattern for shading correction has been recorded; conveying said recording medium having said density pattern recorded thereon in a direction that substantially matches the lengthwise direction of said density pattern at a speed slower than the speed at which said density pattern was recorded; detecting said density pattern by a detection means; and obtaining shading correction data based on the detection result of said detection means.

The phrase “obtaining shading correction data based on the detection result” refers to the obtaining of shading correction data by performing operations such as subtracting the data detected by the detection means from the density pattern data utilized when recording the density pattern, normalizing the detected data by the density pattern data, or the like.

According to the present invention, a recording medium having a density pattern for shading correction recorded thereon is obtained, and said recording medium is conveyed in a conveyance direction which is matched to the lengthwise direction of the density pattern. The detection means is fixedly provided in a position relative to the conveyed recording medium at where detection of the density pattern for shading correction is possible. The shading correction data is obtained by the detection of the band form density pattern by the detection means as the recording medium is being conveyed. Accordingly, the necessity for a mechanism to move the detection means in order to obtain the shading correction data is obviated; thereby simplifying the construction of the apparatus while reducing the cost thereof.

Ideally, the density pattern for shading correction has a uniform density along the direction in which said pattern was recorded. However, unevenness in density occurs due to the effects of shading.

Accordingly, by subtracting the shading correction data obtained based on the detection results of the detection means from the image data that represents an image to be recorded on the recording medium, or by normalizing the image data by the shading correction data, image data can be obtained which can be recorded onto the recording medium as an image having the effects of shading eliminated therefrom.

Generally, the image is recorded onto the recording medium with the conveyance direction matched to a lengthwise direction thereof. Therefore, the widthwise direction of the recording medium becomes the direction in which the image is recorded thereon in a line form, and the density pattern for shading correction is also recorded in the widthwise direction of the recording medium, in a band form. In the case that the density pattern for shading correction has been recorded in a widthwise direction of the recording medium, there is a necessity that the conveyance direction be matched to the widthwise direction thereof in order for the detection means to detect the density pattern for shading correction. If the image recording apparatus is constructed so that the image drafting means as well as the conveyance means is housed in a housing, in the case that the conveyance means has sufficient space in a direction perpendicular to the conveyance direction of the recording medium, the recording medium may be conveyed in a conveyance direction matched with the widthwise direction thereof. However, in the case that the conveyance means does not have sufficient space in a direction perpendicular to the conveyance direction of the recording medium, the presence of the housing prevents the conveyance of the recording medium if the conveyance direction is matched to the widthwise direction thereof.

Accordingly, for cases as described above, if an opening is formed in said housing in the vicinity of the aforementioned conveyance means, extending in the direction of conveyance thereof for the recording medium to pass therethough, conveyance of the recording medium becomes possible, even if the conveyance direction is matched to a widthwise direction thereof.

In the case that the image drafting means is a thermal head, there is no necessity to utilize a photosensitive material as the recording medium. Therefore, the necessity to consider the photosensitivity of the recording medium having the density pattern for shading correction recorded thereon is obviated, and the handling of the recording medium may be performed with ease.

By utilizing a conveyance means that is capable of varying the conveyance speed of the recording medium and setting said speed during detection of the density pattern for shading correction to be slower than the speed at which said density pattern was recorded, the density pattern for shading correction can be detected with a high degree of accuracy. Therefore, shading correction can be performed with a high degree of accuracy.

### BRIEF DESCRIPTION OF THE DRAWINGS

FIG. 1 is a schematic view that shows an image recording apparatus according to an embodiment of the present invention.

FIG. 2 is a schematic view that shows the operation of the image recording apparatus shown in FIG. 1.

FIG. 3 is a schematic view showing the construction of an image recording apparatus according to an alternate embodiment of the present invention.

### DESCRIPTION OF THE PREFERRED EMBODIMENTS

Hereinafter, the embodiments of the present invention will be described with reference to the attached figures.

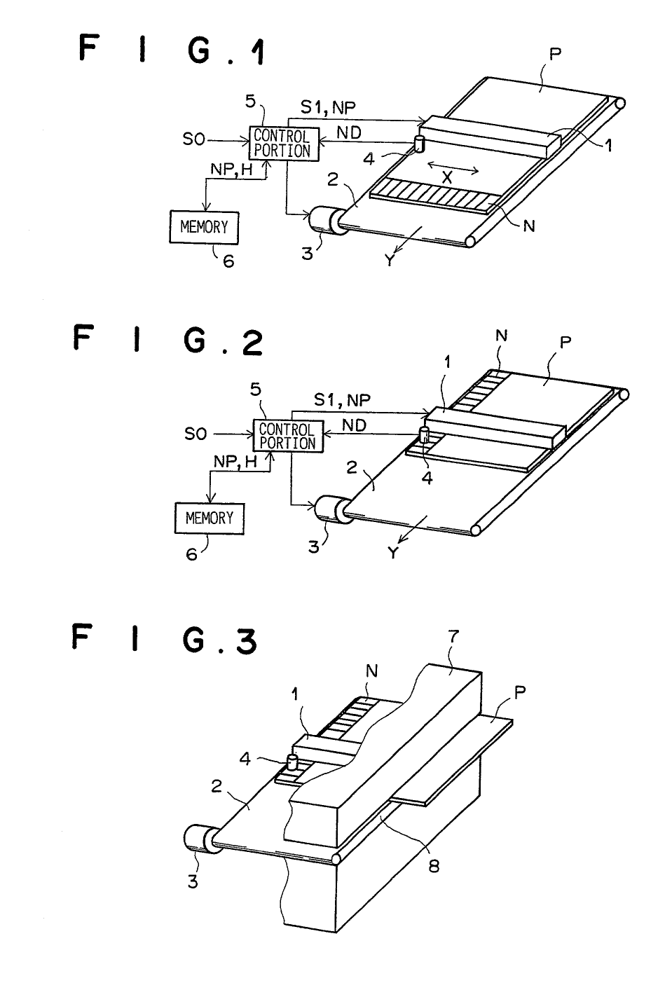

FIG. 1 is a schematic view showing the structure of an image recording apparatus according to an embodiment of the present invention. As shown in FIG. 1, the image recording apparatus of the present embodiment is a thermal transfer printer comprising: a thermal head 1 that has a plurality of thermal elements arranged in a line that drafts an image represented by image data S0 in line form in a main scan direction (the direction indicated by the arrow X in the figure) on a recording sheet P; an endless belt 2 that causes the recording sheet P to be sub scanned in the direction indicated by the arrow Y (hereinafter referred to as the Y direction) a motor 3 that drives the endless belt 2; a CCD 4 that reads out a density pattern for shading correction N which has been recorded on the recording sheet P as will be described later; a control portion 5 that controls the driving of the motor 3, the input of image data S0 to the thermal head 1, and the detection of the density pattern N by the CCD 4; the control portion 5 also obtains corrected image data S1 by forming shading correction data H from the density pattern N detected by CCD 4, and correcting image data S0 during recording of the image onto recording sheet P based on the shading correction data H; and a memory 6 that records shading correction data H and density pattern data NP, used to obtain the density pattern N. The CCD 4 is fixed in the vicinity of the thermal head 1 in a right hand position facing the conveyance direction of recording sheet P.

The thermal head 1 corresponds to the image drafting means, the endless belt 2 and the motor 3 correspond to the conveyance means, and the CCD 4 corresponds to the detection means.

The operation of the present embodiment will now be described. First, the recording of the density pattern N onto the recording sheet P will be described. The recording sheet P is set on to the endless belt 2 so that its lengthwise direction matches the conveyance direction. The control portion 5 reads out density pattern data NP from the memory 6 and inputs said data to the thermal head 1. The recording sheet P is conveyed in the Y direction by the endless belt 2 by driving the motor while the thermal head 1 is driven. Thereby, the density pattern N, which extends in a main scan direction, that is, the widthwise direction of the recording sheet P is recorded at a predetermined distance from the leading edge thereof. Note that the density pattern data NP is data that is capable of recording a band form image of uniform density, and ideally, the density pattern N is a band form image of uniform density that extends in a main scan direction of recording sheet P.

Next, the obtainment of the shading correction data H will be described. The recording sheet P is cut to be of a length equal to or less than the width of the endless belt 2, then set on the endless belt 2 as shown in FIG. 2. The reason for cutting the recording sheet P is because the thermal head 1, the endless belt 2 and the other constituent parts of the image recording apparatus of the present embodiment are housed within a housing, and the presence of the housing makes it impossible to convey the recording sheet P if the conveyance direction is matched to the widthwise direction thereof. Note that if the endless belt 2 possesses a width greater than the length of the recording sheet P, there is no necessity to cut the recording sheet P.

The control portion 5 drives the CCD 4 in addition to the motor 3 as it stops the driving of thermal head 1, and conveys the recording sheet P in the Y direction via the endless belt 2. Note that at this time, the driving of the motor 3 is controlled so that the conveyance speed is slower than the conveyance speed at which the image was recorded. As the CCD 4 is fixed in a position in the vicinity of the thermal head 1 in a right hand position facing the conveyance direction of the recording sheet 4, the CCD 4 detects the density pattern N is detected by the conveyance of recording sheet P, and detected density pattern data ND is obtained. The detected density pattern data ND is input into the control portion 5, where it is either subtracted from the density pattern NP or normalized by the density pattern NP, thereby yielding shading correction data H. Shading correction data H is recorded in the memory 6. Here, the density pattern N is ideally a band form image of uniform density. However, due to shading caused by unevenness in the thermal elements that constitute the thermal head 1, the density pattern N exhibits uneven density in a main scan direction of the recording sheet P. Accordingly, shading correction data H represents the density unevenness in a main scan direction that will be included in an image to be recorded on the recording sheet P.

Next, the recording of image data S0 onto the recording sheet P will be described. Image data S0 is input into control portion 5. Here, shading correction is performed based on shading correction data H, and corrected image data S1 having the effects of shading eliminated therefrom is obtained. The shading correction is performed by either subtracting the shading correction data H from the image data S0, or by normalizing the image data S0 by shading correction data H.

A new recording sheet P is set on the endless belt 2 so that its lengthwise direction matches the conveyance direction thereof. The control portion 5 drives the thermal head 1 while conveying the recording sheet P in the Y direction via the endless belt 2 by driving the motor 3. Thereby, an image having shading correction performed thereon is recorded onto recording sheet P.

As has been described above, in the present embodiment, the recording sheet P is conveyed in a direction that matches the direction in which the density pattern N has been recorded. This allows the fixed CCD 4 to detect the density pattern N, thus obtaining the shading correction data H. Thus, the necessity for a mechanism to move the CCD 4 in order to obtain the shading correction data is obviated, therefore simplifying the construction of the apparatus while reducing its cost.

In addition, as the present embodiment utilizes a thermal head 1, the recording sheet P can be of a non-photosensitive material. Accordingly, the necessity to consider the photosensitivity of the recording sheet P having the density pattern N recorded thereon is obviated, and the handling, such as the cutting and the setting on the endless belt 2 thereof, may be performed with ease.

Further, as the recording sheet P is conveyed at a slower speed during the detection of density pattern N than the conveyance speed during the recording of an image thereon, the density pattern N can be detected with a high degree of accuracy. Therefore, shading correction of image data S0 can be performed with a high degree of accuracy.

Note that with regard to the image recording apparatus of the present invention, a slit 8 may be formed in the housing 7 that houses the constituent parts that constitute the image recording apparatus in the vicinity of the endless belt 2 extending in the direction of conveyance thereof as shown in FIG. 3. By forming the slit 8 in the housing 7, even when the conveyance direction is matched to the widthwise direction of the recording sheet P, by having the recording sheet P pass through the slit 8, the density pattern N may be detected without cutting the recording sheet P.

In addition, with regard to the aforementioned embodiments, the present invention has been applied to a thermal transfer that performs the recording of an image by the use of a thermal head 1. However, the present invention may be applied to a laser printer comprising a laser light source that emits a laser light and a modulator that modulates the laser light according to the image data S0 as well.

Further, in the aforementioned embodiments, the recording sheet P has been set on the endless belt 2 with its widthwise direction matched to the conveyance direction at the time that the density pattern N was to be detected. However, the recording sheet P may be set on the endless belt 2 with its lengthwise direction matched to the conveyance direction at the time that the density pattern is to be detected, and a rotating mechanism may be provided that matches the conveyance direction of recording sheet P to the widthwise direction thereof, either automatically or by the action of an operator.

Still further, in the aforementioned embodiments, the conveyance speed of the recording sheet P has been set to be slower during the detection of the density pattern N therefrom than during the recording of the image thereon, but this is not particularly necessary.

What is claimed is:

1. An image recording apparatus comprising:
an image drafting means that drafts a line form image on a portion of a recording medium; and
a conveyance means that conveys said recording medium in a direction substantially perpendicular to the lengthwise direction of said drafted line form image; wherein said image is recorded two dimensionally on said recording medium by said conveyance means conveying said recording medium in said conveyance direction as said image drafting means drafts said line form image;
further comprising a detection means fixedly positioned in relation to said conveyed recording medium.

2. An image recording apparatus as defined in claim 1, wherein:
said image drafting means as well as said conveyance means are provided within a housing, and an opening is provided in said housing in the vicinity of the aforementioned conveyance means, extending in said conveyance direction.

3. An image recording apparatus as defined in claim 1, wherein:
said image drafting means is a thermal head.

4. An image recording apparatus as defined in claim 2, wherein:
said image drafting means is a thermal head.

5. An image recording apparatus as defined in any one of claims 1-4, wherein:
said conveyance means is capable of varying the conveyance speed of said recording medium.

6. A method of shading correction that employs the image recording apparatus as defined in any one of claims 1-4, comprising the steps of:
recording a density pattern for shading correction on a recording medium;
obtaining said recording medium on which said density pattern for shading correction has been recorded;
conveying said recording medium having said density pattern recorded thereon in a direction that substantially matches the lengthwise direction of said density pattern;
detecting said density pattern by a detection means; and
obtaining shading correction data based on the detection result of said detection means.

7. A method of shading correction that employs the image recording apparatus as defined in claim 5, comprising the steps of:
recording a density pattern for shading correction on a recording medium;
obtaining said recording medium on which said density pattern for shading correction has been recorded;
conveying said recording medium having said density pattern recorded thereon in a direction that substantially matches the lengthwise direction of said density pattern at a speed slower than the speed at which said density pattern was recorded;
detecting said density pattern by a detection means; and
obtaining shading correction data based on the detection result of said detection means.
